(19) United States
(12) Patent Application Publication
(10) Pub. No.: US 2010/0315287 A1
(43) Pub. Date: Dec. 16, 2010

(54) INDEPENDENT ALTITUDE MEASUREMENT IN SATELLITE POSITIONING SYSTEM

(76) Inventor: Yuri Karpitski, Voronezh (RU)

Correspondence Address: COOL PATENT, P.C.;c/o CPA Global, P.O. BOX 52050, MINNEAPOLIS, MN, 55402, US

(21) Appl. No.: 12/680,281

(22) PCT Filed: Sep. 28, 2007
(86) PCT No.: PCT/RU07/00526

§ 371 Date: Aug. 30, 2010

(51) Int. Cl. G01S 19/45

(52) U.S. Cl. 342/357.28

(57) ABSTRACT

A device and method for independent altitude measurement in a satellite positioning system.

### BACKGROUND

Many devices today utilize the technology of satellite positioning systems, such as, for instance, devices comprising Global Positioning System (GPS) receivers. GPS is a satellite positioning system based on a constellation of twenty-four satellites orbiting around the earth that broadcast precise data signals. In a particular embodiment, a satellite may transmit two signals, an L1 signal and an L2 signal. The L1 signal may be modulated with two pseudo-random noise codes, a protected code and a course/acquisition (C/A) code. According to a particular embodiment, a satellite may have its own unique pseudo-random noise code. A GPS receiver may measure the time required for a signal to travel from the satellite to the receiver by generating a replica of the pseudo-random noise code transmitted by the satellite and precisely synchronizing the two codes to determine how long the satellite's code took to reach the GPS receiver. Location determination methods may include obtaining signals from at least four satellites, for measuring the following coordinate parameters of a receiver: time, latitude, longitude and altitude. Thus, GPS receivers may locate themselves anywhere on the planet where a direct view of the GPS satellites is available.

A positioning device utilizing GPS may be an effective tool in finding a location or determining a position. However, a device utilizing GPS may be unsuitable for urban outdoor and indoor positioning applications due to satellite signal blocking and multipath propagation.

### BRIEF DESCRIPTION OF THE DRAWINGS

FIG. 1 illustrates a particular embodiment of a satellite positioning system.

FIG. 2 illustrates a particular embodiment of a satellite positioning system.

FIG. 3 is a block diagram illustrating location determination process in a particular embodiment of a satellite positioning system.

### DETAILED DESCRIPTION

In the following detailed description, numerous specific details are set forth in order to provide a thorough understanding of claimed subject matter. However, it will be understood by those skilled in the art that claimed subject matter may be practiced without these specific details. In other instances, well-known methods, procedures, and components have not been described in detail so as not to obscure claimed subject matter. Throughout this disclosure the terms “location” and “position” are used interchangeably and are intended to refer to a physical place occupied by a person or object.

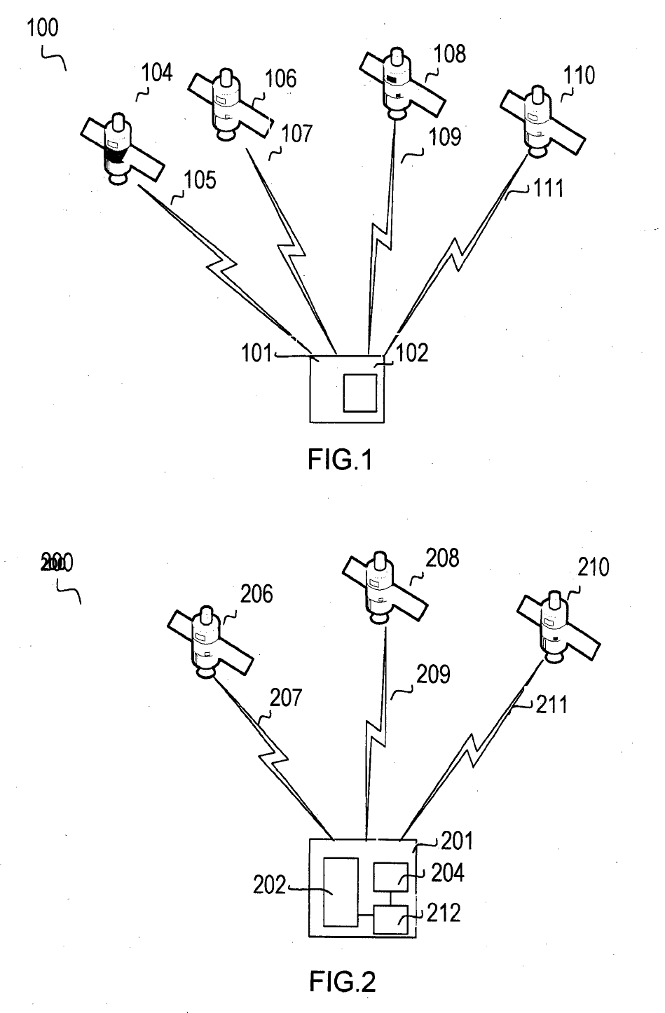

FIG. 1 illustrates an embodiment of a satellite positioning system (SPS) 100. In a particular embodiment, SPS 100 may be a global navigation satellite system capable of providing geo-spatial positioning with global coverage. Two examples of global navigation satellite systems are: the United States NAVSTAR Global Positioning System (GPS) and the Russian GLObal NAvigation Satellite System (GLONASS). In satellite positioning system 100, SPS device 101 may comprise an SPS receiver 102. SPS receiver 102 may receive satellite signals and may calculate its position based on satellite signals 105, 107, 109 and 111. In a particular embodiment, SPS receiver 102 may calculate its position by determining a number of parameters, such as, for instance, three spatial coordinates and local time shift. In a particular embodiment, such calculations may be performed using signals received from four satellites, such as, satellites 104, 106, 108 and 110. However, this is merely an example of a satellite positioning system comprising four satellites and claimed subject matter is not so limited. For example, in another embodiment, another number of satellites may be used for position determination. In general the accuracy of position determination may increase as the number of satellites used increases.

Satellite positioning systems may provide high position accuracy in open sky conditions. However, because of interference such as satellite signal blocking and multipath propagation, location accuracy may be low in urban outdoor and indoor conditions. For example, in a particular embodiment, SPS receiver 102 may have several meters accuracy in open sky conditions. However, in an urban outdoor environment, SPS receiver 102 accuracy may be greater than 100 m. Indoor location determination accuracy may be very low for SPS receiver 102, such as, a range of 400 m to 1000 m or more. Unfortunately, requirements for indoor accuracy may be higher than for outdoor accuracy.

In a particular embodiment, buildings and other structures in urban outdoor conditions may lead to signal interference and multi-path propagation decreasing SPS receiver 102 location determination accuracy. SPS receiver 102 accuracy in indoor conditions may be diminished due to interference caused by structures such as walls and ceilings. Satellite signals often cannot propagate well through these structures. Therefore, SPS receivers may robustly receive signals from only one or two satellites.

In a particular embodiment, SPS receiver 102 may calculate latitude, longitude, altitude, velocity, heading and precise time of day. However, altitude may be difficult for SPS receiver 102 to accurately determine because of generally poor geometrical satellite distribution for vertical coordinate measurement. This is because the satellites which signals are received are always under SPS receiver 102. Horizontal coordinates may not be substantially affected by geometrical satellite distribution given that satellite signals may be received from different directions. The influence of geometrical satellite distribution on location accuracy may be measured by a Dilution of Precision (DOP) factor. In a particular embodiment, Vertical DOP (VDOP) values may influence altitude estimation accuracy and Horizontal DOP (HDOP) values may influence a horizontal coordinate's accuracy. According to a particular embodiment, VDOP values may be larger than HDOP values. Therefore, location accuracy in the horizontal plane may be greater than in the vertical plane. In other words, latitude and longitude measurements may have greater accuracy than altitude measurements due in part to geometrical satellite distribution.

FIG. 2 illustrates an embodiment of a satellite positioning system (SPS) 200. In a particular embodiment, SPS 200 may comprise three satellites 206, 208 and 210 and SPS device 201. For instance, when signals of only three satellites of SPS system 200 are available at SPS receiver 202 because of a poor signal propagation condition around the receiver location. According to a particular embodiment, SPS device 201 may comprise SPS receiver 202, independent altimeter 204 and location processor 212. In a particular embodiment, SPS receiver 202 may receive satellite signals 207, 209 and 211 via an antenna (not shown). According to a particular embodiment, independent altimeter 204 may independently determine the altitude of SPS device 201 without using satellite signals 207, 209 and 211. According to a particular embodiment, location processor 212 may calculate the position of SPS device 201 based at least in part on the received satellite signals 207, 208 and 211 and the altitude determination made by independent altimeter 204. According to a particular embodiment, an independent altitude determination may be more accurate than altitude determinations calculated based on received satellite signal data. In a particular embodiment, improving the accuracy of an altitude determination may enable more accurate calculation of other coordinates and thereby improve overall accuracy of the location determination by location processor 212.

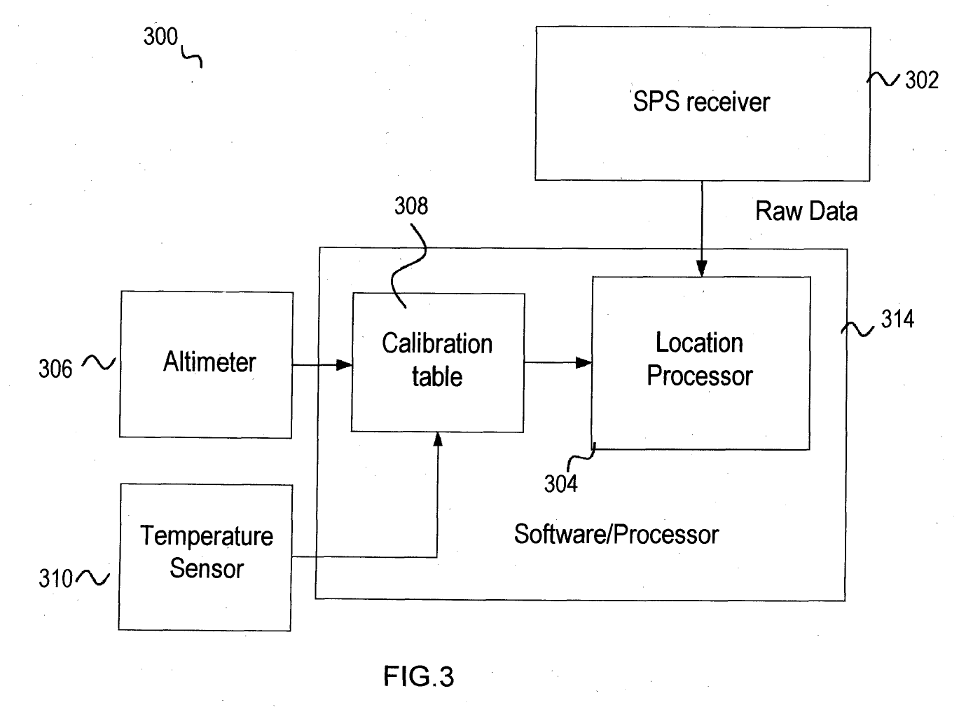

In a particular embodiment, an independent altitude determination may be made by a variety of methods. For instance, independent altimeter 204 may comprise pressure sensors chips or another altitude related detecting device. In a particular embodiment, pressure sensors may be highly precise. The accuracy of an independent altitude determination may be improved further by a variety of methods, such as, for instance, incorporating a temperature compensation measurement by adding a temperature sensor (not shown) and/or an intermediary calibration table (as shown in FIG. 3). Such an intermediary calibration table may calibrate independent altitude determinations with temperature measurements to increase accuracy. However, these are merely examples of methods of determining altitude independent of data received via satellite signals and claimed subject matter is not so limited.

In a particular embodiment, independent altimeter 204 may be a compact and inexpensive digital device or sensor and may be incorporated into a variety of SPS devices. According to a particular embodiment, SPS device 201 may be a variety of devices such as, for instance, mobile phones, personal digital assistants (PDAs), laptop computers, and/or any of a variety of portable electronic devices. However, these are merely examples of independent altimeters and SPS devices and claimed subject matter is not so limited.

In a particular embodiment, obtaining an independent altitude determination for location determination may enable reducing the minimum number of satellites used for location determination from four to three while maintaining good positioning accuracy. Accordingly, with independent altitude determination, location determination may be made with three satellites in view of SPS receiver 202 because only three unknown parameters (latitude, longitude and time shifts) remain. In a particular embodiment, reducing the number of satellites may reduce the impact of signal interference and multi-path propagation and may significantly improve accuracy of location determination in indoor and urban outdoor conditions.

In a particular embodiment, obtaining an independent altitude determination may enhance the accuracy of location determination even when a number of satellites in view is more than three. For instance, if altitude is determined it can be excluded from parameters which have to be determined based on signals received from satellites. Correspondingly all received satellite's signals may be used to get maximum accuracy of three remaining parameters determination such as, latitude, longitude and time shift).

FIG. 3 is a block-diagram illustrating a particular embodiment of a process 300 for incorporating an independent altitude measurement into an SPS system. According to a particular embodiment, SPS receiver 302 may provide data such as, for example, pseudo distances and/or satellite signal strength to location processor 304. In a particular embodiment, SPS receiver 302 may not communicate location coordinates to location processor 304 rather SPS receiver 302 may send raw data to location processor 304. Such raw data may comprise, for instance, pseudo distances, satellite signals strengths, and so on. In another particular embodiment, SPS receiver 302 may calculate and communicate location coordinates to location processor 304. However, these are merely examples of methods of communicating and processing location data in an SPS system and claimed subject matter is not so limited.

According to a particular embodiment, altitude data may be generated by a number of methods including air pressure measurement in altimeter 306 and communicated to location processor 304. Alternatively, altitude data may be sent to intermediary calibration table 308. According to a particular embodiment, calibration data may be generated by temperature sensor 310 and also provided to intermediary calibration table 308. Such calibration data may be, for instance, temperature data. According to a particular embodiment, altitude data may be calibrated with temperature data in intermediary calibration table 308. However, these are merely examples of methods of communicating and processing location and calibration data in an SPS system and claimed subject matter is not so limited.

In a particular embodiment, location processor 304 may calculate position coordinates based, at least in part, on input data from SPS receiver 302 and independent altitude data generated by altimeter 306. According to a particular embodiment, a location algorithm may be implemented as a software algorithm running on general purpose processor 314. Alternatively, in a particular embodiment, location processor 304 may calculate position coordinates based at least in part, on input data from SPS receiver 302 and calibrated independent altitude data. As described above, altitude data may be calibrated with temperature data by intermediary calibration table 308. According to a particular embodiment, an altitude calibration algorithm may be implemented as a software algorithm running on a general purpose processor 314. Alternatively SPS receiver 302 and location processor 304 may comprise a common location determination device (not shown). Accordingly, implementation of the location determination algorithm based on the satellite signal processing and separate altitude measurement may be performed in various ways. However, these are merely examples of methods of calculating position coordinates in a satellite positioning system using independent altitude data and claimed subject matter is not so limited.

While certain features of claimed subject matter have been illustrated as described herein, many modifications, substitutions, changes and equivalents will now occur to those skilled in the art. It is, therefore, to be understood that the appended claims are intended to cover all such embodiments and changes as fall within the spirit of claimed subject matter.

1. An apparatus for location determination in a satellite positioning system comprising:
a satellite positioning device comprising:
a satellite data signal receiver coupled to a location processor;
an altitude determining device coupled to the location processor wherein the altitude determining device is capable of determining the altitude of the satellite positioning device independent of satellite data signals received; and
wherein the altitude determining device is capable of generating altitude data to supplement positioning data from the satellite data signal receiver.

2. The apparatus of claim 1 further comprising:
a sensor coupled to a calibration table wherein the calibration table is an intermediary coupled to the processor and the altitude determining device and wherein the altitude determining device is coupled to the processor through the calibration table.

3. The apparatus of claim 2 wherein the sensor comprises: an air pressure sensor or a temperature sensor, or combinations thereof.

4. The apparatus of claim 1 wherein the satellite data signal receiver comprises an antenna capable of receiving satellite data signals from the satellite positioning system.

5. The apparatus of claim 1 wherein the satellite positioning device comprises: a portable electronic device, a mobile phone, a homing device, a portable digital assistant or a laptop computer, or combinations thereof.

6. A method comprising:
receiving raw satellite data from one or more satellites;
determining an altitude of a satellite positioning device independent of the raw satellite data received from the one or more satellites;
generating altitude data, based at least in part, on the independently determined altitude of the satellite positioning device; and
determining a location of the satellite positioning device based at least in part on altitude data.

7. The method of claim 6 wherein determining the location of the satellite positioning device further comprises:
generating temperature data;
calibrating the altitude data with the temperature data; and
determining an updated location of the satellite positioning device based at least in part on the calibrated altitude data.

8. The method of claim 6 wherein determining the location of the satellite positioning device further comprises:
receiving the raw satellite data from a satellite data signal receiver;
determining one or more location coordinates based at least in part on the received raw data; and
wherein determining the location of the satellite positioning device is based at least in part on the one or more location coordinates.

9. The method of claim 6 wherein determining the location of the satellite positioning device further comprises:
processing the raw satellite data in a satellite data signal receiver processor to determine one or more location coordinates;
receiving the one or more location coordinates from the satellite data signal receiver processor at a location processor; and
wherein determining the location of the satellite positioning device is based at least in part on the one or more location coordinates.

10. The method of claim 6 wherein determining the location of the satellite positioning device further comprises:
receiving the raw satellite data from a satellite data signal receiver; and
wherein determining the location of the satellite positioning device is based at least in part on the raw data.

11. The method of claim 6 further comprising air pressure data and wherein altitude data is based at least in part on the air pressure data.
